(19) United States
(12) Patent Application Publication
(10) Pub. No.: US 2011/0064542 A1
(43) Pub. Date: Mar. 17, 2011

(54) TILTABLE ROLLER BED TRAILER

(76) Inventors: James N. Hertzog, Greenwood, MO (US); Jerry L. Page, Butler, MO (US)

(21) Appl. No.: 12/883,164

(22) Filed: Sep. 15, 2010

Related U.S. Application Data
(60) Provisional application No. 61/242,588, filed on Sep. 15, 2009.

(51) Int. Cl. A01D 90/10; B60P 1/04; B60P 1/52

(52) U.S. Cl. 414/24.5; 414/813

(57) ABSTRACT

The present invention is directed to an improved combination hay trailer and tiltable bed and a method related thereto for loading and unloading round bales, the improvement comprising a rotary hinge assembly positioned along the combination and adapted for angular rotation of the bed about the trailer, the hinge assembly including an outer hinge structure spaced from an inner hinge structure, the inner hinge structure associated with one of the bed and trailer, the outer hinge structure being associated with the remaining bed or trailer, and a hinge sleeve extending through said hinge assembly, wherein said tiltable bed is biased downwardly.

### CROSS-REFERENCE TO RELATED APPLICATION

This application claims priority under 35 U.S.C. 119(e) and 37 C.F.R. 1.78(a)(4) based upon copending U.S. Provisional Application Ser. No. 61/242,588 for TILTABLE ROLLER BED TRAILER, filed Sep. 15, 2009, the disclosure of which is incorporated herein by reference.

### FIELD OF THE INVENTION

This invention relates generally to industrial agricultural equipment and more specifically to a loadable transport vehicle which is constructed to receive large rolled bales of hay or the like, transport them and distribute them to the desired location.

### BACKGROUND OF THE INVENTION

Current hay farming techniques are generally directed toward large commercial farming operations, with automated machinery handling many aspects of farming production. In the past, however, hay was cut from the field using horse drawn wagons, with the hay being collected in the wagons for distribution. As hay production evolved, additional machinery was developed which aided in cutting and gathering the hay into bundles which were later cut, shaped and collected for transport to a destination location where the hay was stored. As methods and technology developed which were capable of handling and transporting more hay in a shorter timeframe, so too did the size and weight of hay bales increase. So much so, in fact, that it is no longer practical for a person to manually manipulate the bales in many cases. Current round hayrolls are often six to eight feet in diameter and in some cases weigh more than a ton depending on moisture content and additional factors.

While a variety of equipment has been developed for handling standard rectangular hay bales, limited machinery has been developed for handling the larger round hay bales. Equipment which has been developed in this area includes formation machinery such as tines or other tractor attachments for picking up the hay bales and transferring them to another vehicle for transport. However, acceptable transport trailers have not developed apace with other equipment associated with the handling of round bales. Accordingly, there exists a need for a specialized trailer for transporting the hay rolls from the field for even distribution to a delivery site, the rolls being delivered without the need for extra machinery or equipment.

### SUMMARY OF THE INVENTION

The present invention provides an improved combination hay trailer and tiltable bed and method related thereto for loading and unloading round bales, said improvement comprising a hinge assembly positioned along said combination and adapted for angular rotation of the bed about the trailer, said hinge assembly including a rotary hinge with an outer hinge structure spaced from an inner hinge structure, said inner hinge structure associated with one of the bed and trailer, said outer hinge structure being associated with the other of said bed and trailer, and a hinge sleeve extending through said hinge assembly, wherein said tiltable bed is biased downwardly.

### BRIEF DESCRIPTION OF THE DRAWINGS

FIG. 1 is a side perspective view of a combination hay trailer and tiltable bed in receipt of hayrolls and adapted for receiving and angularly unloading hayrolls.

FIG. 2 is a partially exploded side perspective view of the combination hay trailer and tiltable bed in accordance with FIG. 1.

FIG. 3 is a side perspective view of the combination hay trailer unloading hayrolls in accordance with FIG. 1.

FIG. 4A is a partial side perspective view of the combination hay trailer and tiltable bed in accordance with FIG. 1.

FIG. 4B is a partial side perspective view of the combination hay trailer and tiltable bed in accordance with FIG. 1.

FIG. 4C is a partial side perspective view of the combination hay trailer and tiltable bed in accordance with FIG. 1.

FIG. 5 is a partial side exploded perspective view of the combination in accordance with FIG. 1.

FIG. 6 is a partial top perspective view of the tiltable bed in accordance with FIG. 1.

### DETAILED DESCRIPTION OF THE INVENTION

### I. Introduction

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

### II. Combination Hay Trailer and Tiltable Bed

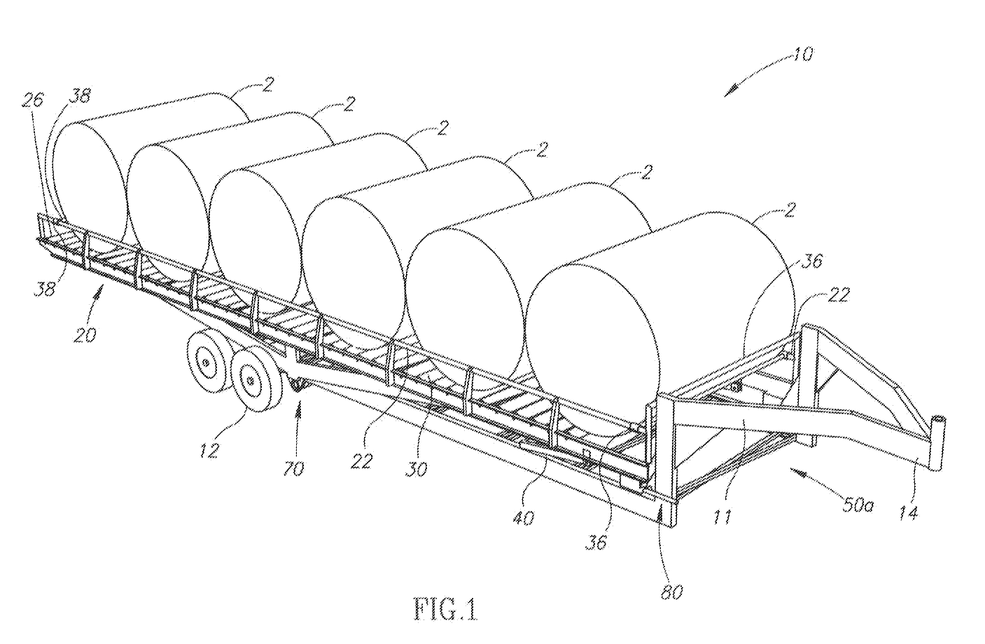

The present invention can be used for transporting round bales also referred to herein as hay rolls and includes features which provide for convenient and expedited loading, transport and unloading. The embodiment shown in FIG. 1 includes a combination hay trailer and tiltable bed which are generally indicated by reference numeral 10. The combination 10 is shown associated with plural hay rolls 2 spaced along a generally horizontal, tiltable bed 20 supported by a trailer 11 and adapted for transport. The illustrated hayrolls are generally large round bales which may vary in weight from about 800 to 1600 pounds and in width from about four to six feet.

The combination 10 will be fabricated from suitable materials to handle the weight of the transported hayrolls 2 such as wood, metals or others. Also, the tiltable bed 20 is constructed to provide for angular rotation of the tiltable bed 20 from a generally horizontal position to an angled position. The rear portion of the tiltable bed 20 is associated with a loading edge 26 positioned near the ground for receipt or delivery of the hayrolls 2.

The tiltable bed 20 is generally rectangularly shaped with a pair of side rails 22 and is traversed by a plurality of rollers 30 positioned in an overlying orientation with respect to the hay trailer 11. The rollers are adapted for receipt of plural hayrolls 2. The tiltable bed 20 may have varying dimensions. As illustrated the combination hayroll trailer and tiltable bed 10 allows for transport of six hayrolls 2 in a side-by-side orientation but may accommodate varying amounts according to the size of the tiltable bed 10, size of the bales 10, and bale orientation which may optionally be end-to-end.

In accordance with another feature of the invention, the tiltable bed 20 is selectively rotatable relative to the hay trailer 11 and may be rotated about a hinge assembly 70 to permit loading and unloading of the hayrolls 2. Generally, the tiltable bed 20 is biased for rotation of the rear portion of the tiltable bed 20 toward the ground in an unloading condition. During transport, the tiltable bed 20 may be maintained in a substantially level or neutral position using a latching mechanism 80. Hayrolls 2 may be positioned along the bed 20 so as to bias the bed 20 towards the neck 14 or the rear. A pivot axis associated with the hinge assembly 70 also may optionally be located at different points along the length of the trailer 11 to bias the bed 20 towards the neck 14 or rear. A front and rear stop 36, 38 allow for positioning of the hayrolls 2 to present a biased or neutral orientation, facilitating delivery of the transported hayrolls upon arriving at the desired destination. While the combination 10 allows for a rotational bias, depending on the desired operation, the operator may align the front and rear stops 36, 38 to adjust the bias and prevent clockwise or counter-clockwise rotation of the tiltable bed 20.

As further illustrated in FIGS. 1-3, latching mechanism 80 is located near the front portion of the trailer 11 for releasable latching of the tiltable bed 20 in the generally horizontal position. In addition, a rotating support stand 40 is also provided which supports the tiltable bed 20 in an unloading orientation. In addition, hinge assembly 70 is provided for rotation of the tiltable bed 20 relative to the hay trailer 11 as further described below.

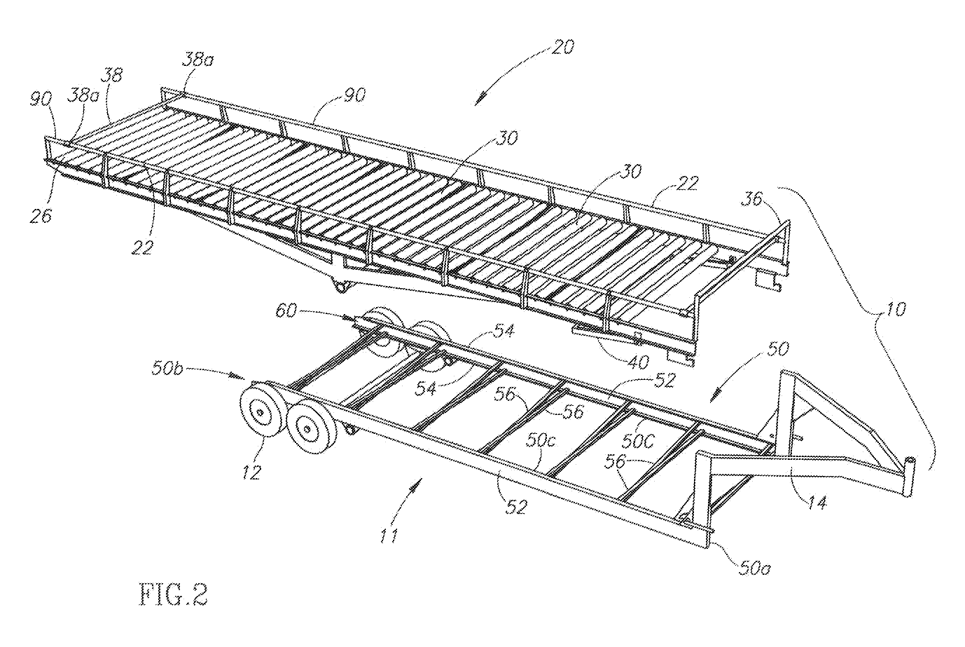

As illustrated in FIG. 2, the trailer 11 is generally defined by a frame 50 including a pair of sides 50c and a pair of longitudinally extended members 32 extending from a front 50a associated with the neck 14 towards a rear 50b generally associated with the wheels 12 and including an inner facing flange 54. A distal end 52a associated with the longitudinally extending members is generally located near the rear 50b. A plurality of traversing members 56 span the longitudinally extended members 52 between the side pair 50c and have complementary angular orientation to inhibit undesired rotational deflection of the hay trailer 11. As shown in FIG. 2, the traversing members 56 are interconnected to the longitudinally extending members 52 along the inner facing flanges 54 using traditional fastening techniques such as welding or mechanical fasteners. The traversing members 56 are regularly spaced along the longitudinally extending members between the front 50a and the rear 50b. Near the rear 50b, the longitudinally extending members 52 present an angled receiver 60 which provides for angular orientation of the tiltable bed 20 in relation to the hay trailer 11.

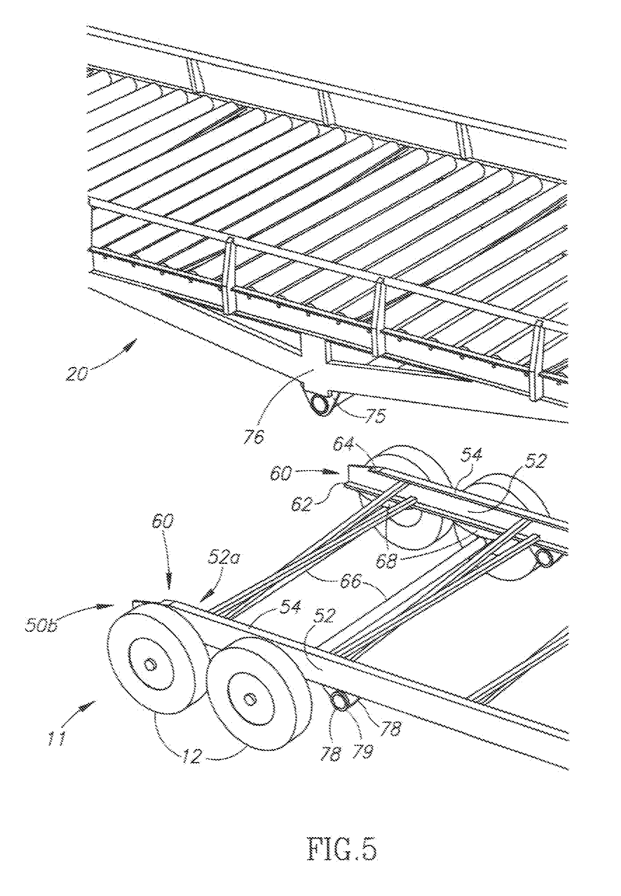

As illustrated more clearly in FIG. 5, the angled receiver 60 includes a pair of projecting tabs 62 associated with the rear 50b of the longitudinally extending members 52 and a directional surface 64 associated with the inner facing flange 54 for receiving and angularly directing the tiltable bed 20 past a lower inner flange and towards the underlying ground surface. As the portion of the tiltable bed 20 associated with the front 50a of the tiltable bed 20 is rotated upwardly, the opposite end associated with the rear 50b is rotated downwardly. The angled receiver 60 generally presents an angle between 5° and 60°, and as illustrated is less than 30°.

The hay trailer 11 also includes a plurality of wheels 12 in a tandem orientation and a neck 14 adapted for towable movement of trailer 11. As a point of reference in the embodiment of FIGS. 1-3, in operation the neck 14 is associated with the front portion 50a, opposite the hinge assembly 70 associated with rear 50b. As illustrated in FIG. 5, the tandem wheels 12 are rotationally supported on an axle 66 connected to the hay trailer 11, for example, by a conventional leaf spring assembly 68, which optionally may extend from the hinge assembly 70 in receipt of the axle 66. Typically, the axle 66 in association with the leaf spring assembly 68 is secured to the longitudinally extending members 52 with, for example, a U-bolt (not shown) providing rotatable support of the axle 66 under the leaf spring assembly 68 during operation of the hay trailer 11.

The latching mechanism 80 secures the tiltable bed 20 against substantial rotation while the hinge assembly 70 provides for pivotal movement of the tiltable bed 20 about a pivot axis extending through the hinge assembly 70. Generally, the tiltable bed 20 presents an angle of rotation about the hay trailer 11 from between 0 to less than 45 degrees. However, a different angle of rotation may be provided by adjusting the distal end 52a of the longitudinally extending members 52 rearwardly or otherwise by modifying the directional surface 64 for alternate angular orientation. The hay trailer 11 also includes a cantilevered configuration in which the center of gravity of the combination hay trailer and tiltable bed 10 is urged towards the hinge assembly 70 for slightly biased rotation of the tiltable bed 20 towards the ground.

As illustrated in FIG. 5, the tiltable bed 20 generally rotates about the pivot point which is associated with hinge assembly 70 which is illustrated as a pair of rotary hinges 74, each including an outer hinge structure 76 and an inner hinge structure 78. While the arrangement may vary, as illustrated the outer hinge structure 76 is associated with the tiltable bed 20 and the inner hinge structure 78 is associated with the hay trailer 11. Alternatively, the outer hinge structure 76 may be associated with the hay trailer 11 and the inner hinge structure may be associated with the tiltable bed 20. A hinge sleeve 79 extends through the outer hinge structure 76 into the inner hinge structure 78 and provides for repeated rotation of the tiltable bed 20 in association with the hay trailer 11. As illustrated in FIG. 1, the hinge sleeve 79 extends longitudinally through the rotary hinge 74 and may be cylindrically and/or frustro-conically configured. In addition, supporting structure 75 extends downwardly from the side rails 22 for connection to the outer hinge structure 76. The inner hinge structure 78 extends downwardly from the longitudinally extending members 52 and is adapted for receiving the outer hinge structure 76. Flanges 73 are mounted to both the inner and outer hinge structures 78, 76 for connection to the hay trailer 11 and tiltable bed 20. Optionally, bearings may be utilized to reduce any undesired friction.

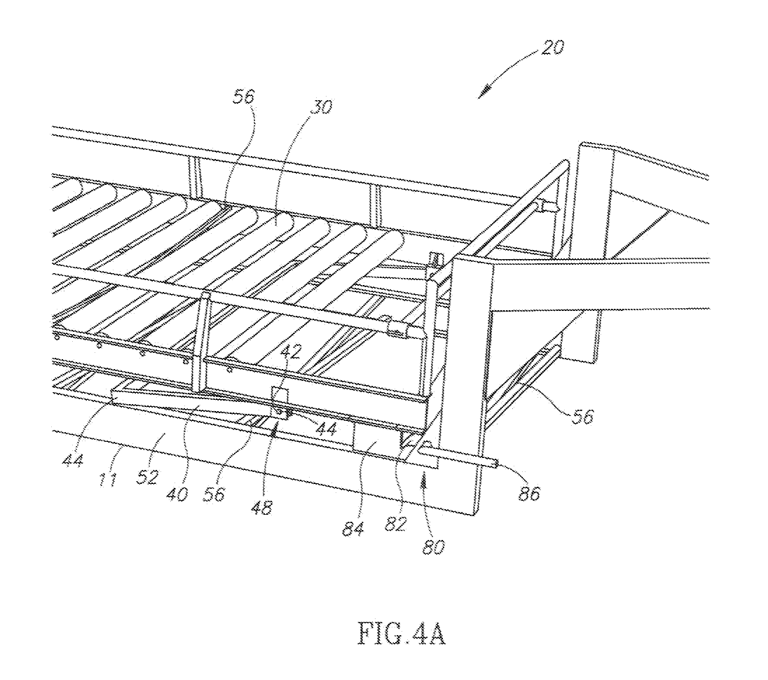

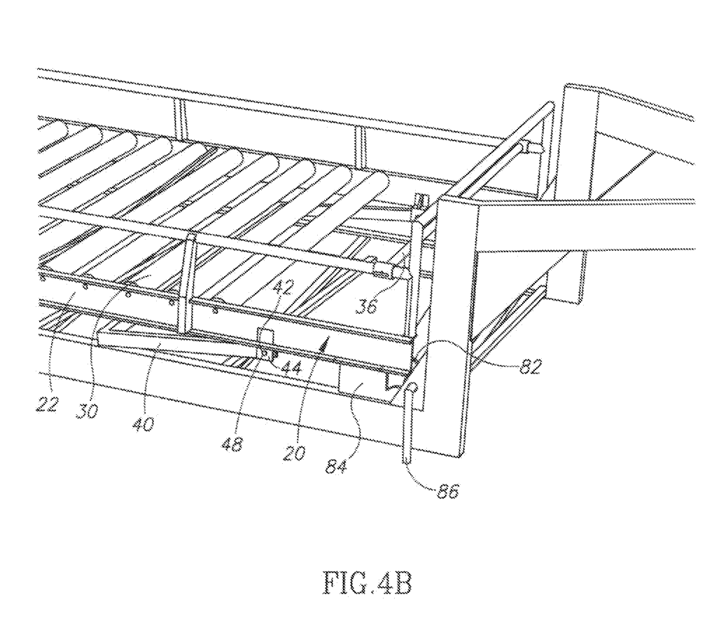

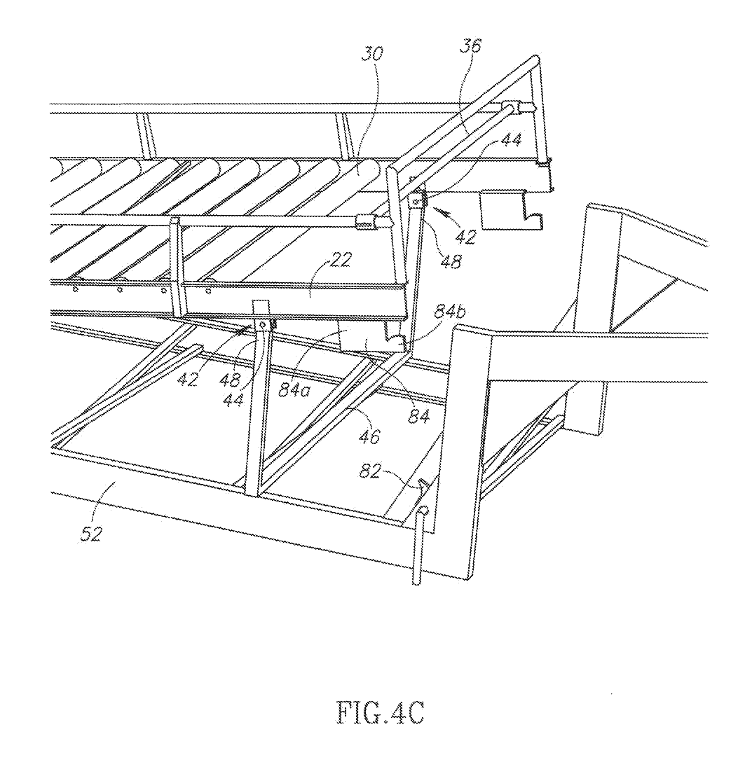

In operation, the hayrolls 2 may be loaded upon the combination hayroll trailer and tiltable bed 10 using a loading machine like a tractor or loader to place the hayrolls 2 upon the tiltable bed 20. The hay combination 10 is then transported to the desired location for unloading. As illustrated in FIGS. 4A-4C, the latching mechanism 80 releasably secures the tiltable bed 20 to the hay trailer 11 during transport of the hayrolls 2 to the desired destination. The handheld actuator 86 is provided for operating the tilting bed 20 from the transport orientation (FIG. 4A) to the unloading orientation (FIG. 4C) where the tilting bed 20 is angularly orientated with respect to the hay trailer 11. In the transport orientation the latching mechanism 80 connectably secures the tilting bed 20 to the hay trailer 11.

The latching mechanism 80 includes a catch 84 comprised of a downwardly extending leg section 84a with an engageable surface 84b extending lengthwise and adapted for receiving the latch which is illustrated as generally hook-shaped and engaging the engageable surface 84b. As illustrated the engageable surface 84b includes an arcuate portion for engagement by the complementary-shaped latch 82. In the unloading orientation, the actuator 86 in communication with the latch 82 is operated, rotating the latch 82 upwardly away from the catch 84, releasing the catch 84 and allowing the tiltable bed 20 to rotate about the pivot point. When it is desired to relatch the tilting bed 20 to the hay trailer 11, the catch 84 positioned near the tiltable bed 20 is rotated towards the hay trailer 11, aligning the leg section 84a for engagement by the latch 82, rotating an upper portion of the latch 82 inwardly towards the catch 84 for engagement of the arcuate engageable surface 84b by the latch 82.

Optionally a locking mechanism (not shown) may be provided to secure the actuator 86 in a retained position to help avoid any unintended operation of the latching mechanism 80. The actuator 86 is designed for simple, easy to use operation, allowing a single user to deliver several hayrolls 2 to the desired destination. In addition, a safety member (also not shown) may be provided for additional security, which if utilized would be removed by the operator prior to operating the latching mechanism 80 to rotate the loading edge 26 of the tiltable bed 20 up or down without the need for any automated devices.

In addition, as the front 50a rotates upwardly during the unloading orientation, the vertical support stand 40 rotates vertically to support the tiltable bed 20. As illustrated in FIG. 4C, the support stand 40 includes a pair of fixed ends 48 opposite a free end 46, each fixed end 48 being secured to the tiltable bed 20 with a clip pin 44 extending through a clip 42. The free end 46 of the stand is adapted for engagement by the longitudinally extending members 52 for supporting an end of the tiltable bed 20 while unloading received hayrolls 2. Once the hayrolls 2 have been delivered, the operator can release the vertical support stand 40 by urging the free side 46 inwardly, rotating the fixed end 48 about the clip pin 44 and rotating the stand 40 towards the tiltable bed 20. After the stand 40 is retracted by rotating it towards the tiltable bed 20, the latching mechanism 80 may be reengaged, securing the tiltable bed 20 to the hay trailer 11.

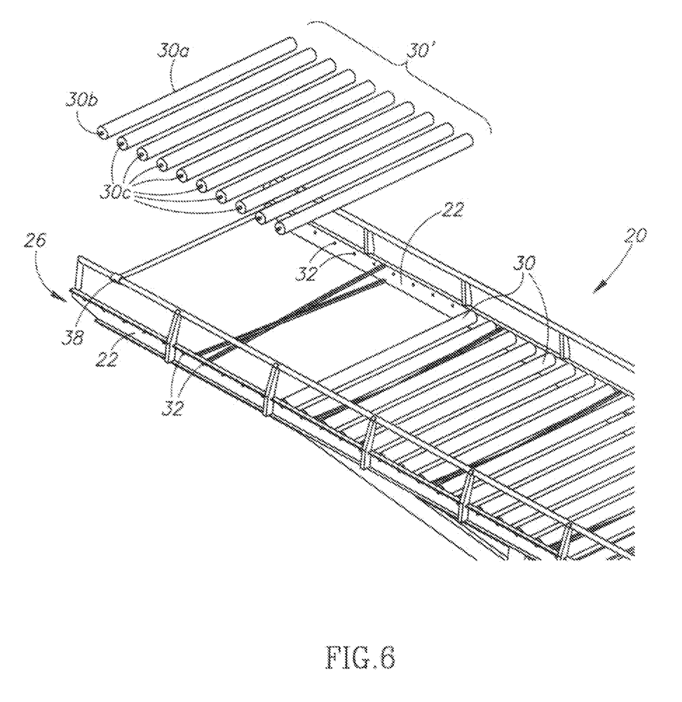

FIG. 6 illustrates the rollers 30 generally in a partially exploded view with some of the rollers 30′ separated from the tiltable bed 20 for visual clarity of the rollers 30 and roller receivers 32. In general, the rollers 30 allow for easy unloading and arrangement of the hayrolls 2. In accordance with one advantage of the present invention, delivered hayrolls 2 are generally arranged similarly to their arrangement while on the tiltable bed 20 during transport. The rollers 30 thus reduce the amount of time and effort required to unload hayrolls 2 in relation to traditional transportation, loading and unloading equipment by allowing the hayrolls to roll off of the tiltable bed 20 in a desirable arrangement at the delivery site.

Plural rollers 30 extend between the side rails 22 and are spaced along the tiltable bed 20. Generally, rollers 30 allow for loading of the hayrolls 2 on and/or off the tiltable bed 20. The rollers 30 may be 4 or 6 inches in diameter or some other dimensioned roller and are fabricated from a material which, depending partly on the numerosity of neighboring rollers, is capable of supporting the weight of the received hayrolls 2. The rollers 30 as illustrated may have independent movement with each roller 30 freely and independently rotatable, or the rollers 30 may utilize interconnecting structure (not shown) such as a chain and gears for coordinated movement between plural rollers 30. In addition, a motor (not shown) may be coupled to the chain and gear assembly providing assistance during loading and unloading operations.

Rollers 30′ are illustrated in FIG. 6 including a cylindrical outer surface 30a rotated about a shaft 30b having ends 30c extending outwardly therefrom. The roller 30 is generally journaled between the longitudinal portions of the side rails 22 with the cylindrical surface 30a adapted for rotation about the shaft 30b. The extended ends 30c of the shaft 30b are configured for receipt by the side rails 22 and adapted for rotational movement. Optionally, the rollers 30 may include an optional bearing member (not shown) providing rotational movement of the outer roller surface 30a in relation to the shaft 30b. The extended ends 30c are received within complementary receiving structure 32 associated with the side rails 22 and preferably space the rollers 30 along the generally horizontal tiltable bed 20. The receiving structure 32 may include a variety of bearings including, but not limited to, journal bearings, shaft bearings or ball bearings. Oil-impregnated bearings adapted for rotationally receiving the extended ends 30c may be positioned along the side rails 22. In one embodiment, the oil impregnated bearings may be radially compressed into the side rails 22 and adapted for rotationally retaining the shaft 30b by a longitudinal channel extending through the bearing. In addition, outer surface 30a may be fabricated from a number of materials and may be smooth or frictionally configured to transport the hayrolls 2 onto or off the tiltable bed 20.

As illustrated in FIG. 2, a rear stop 38 and front stop 36 are provided for preventing unwanted forward and backward movement of the received hayrolls on the tiltable bed 20. The rear stop 38 includes a pair of rear stop collars 38a spaced by a rear retainer 38b, the collars 38a being releasably engaged with a side support 90.

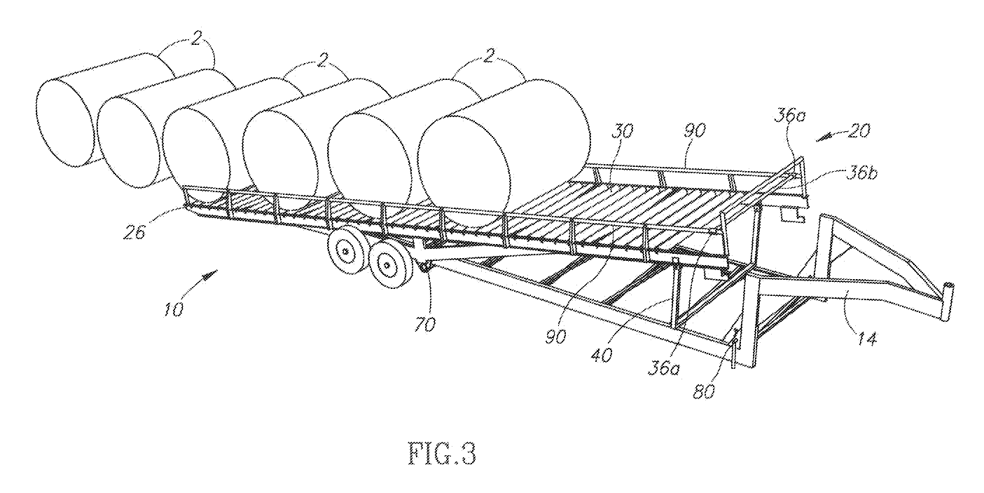

As illustrated in FIG. 3, during transition of the tiltable bed 20 from the generally horizontal or transport orientation, the tiltable bed 20 is rotated about the hinge assembly 70 with the front 50a of the tiltable bed 20 being rotated upwardly. As the front 50a (or the side near the neck 14) of the tiltable bed 20 is rotated up, the rear portion 50b (opposite the front 50a) or loading edge 26 is rotated down. Once the loading edge 26 of the tiltable bed 20 is positioned near the ground, the hayrolls 2 may be unloaded unto the ground. During loading, the hayrolls 2 may be loaded onto the tiltable bed 20 from the ground while the tiltable bed 20 is in a similar angular unloading position or the hayrolls 2 may be loaded from the side associated with the side support 90 while the tiltable bed 20 is maintained in a substantially horizontal orientation. As the hayrolls 2 move across the tiltable bed 20, the rollers 30 may rotate in a corresponding or counteracting manner to assist in controlling or moving the hayrolls 2 along the rollers tiltable bed 20. For example, if present, a motor may assist in control or movement of the hayrolls 2 by rotating the rollers 30 in the desired orientation. Motorized operation of the rollers 30 may reduce undesired slippage of the hayrolls 2 during loading. During side loading, a fork lift may be used to lift the hayrolls 2 onto the tiltable bed 20 by inserting a fork into the center of the hayroll 2 and lifting the hayroll 2 onto the tiltable bed 20 between the side supports 90 while the tiltable bed 20 is generally horizontally orientated.

Once the hayrolls 2 are loaded, the combination hay trailer and tiltable bed 10 is then prepared for transport. To prepare the combination hay trailer and tiltable bed 10 for transport, the rear stop 38 is adjustably secured onto the side supports 90 near the loading edge 26 and the front stop 36 is adjusted nearer to the front 50a for proper positioning of the hayrolls 2 during transport. Similarly, the front stop 36 generally includes a pair of front collars 36a adjustably secured to the side supports 90, the front collar pair 36a being spaced apart by a front retainer 36b. Once secured, the front and rear stops 36, 38 position and help limit undesired movement of the hayrolls 2 during transport as the combination hay trailer and tiltable bed 10 travel to the desired location for unloading.

Having thus described the invention, what is claimed as new and desired to be secured by Letters Patent is as follows:

1. An improved combination hay trailer and tiltable bed for loading and unloading round bales, said improvement comprising:
a hinge assembly positioned along said combination and adapted for angular rotation of the bed about the trailer, said hinge assembly including a rotary hinge with an outer hinge structure spaced from an inner hinge structure,
said inner hinge structure associated with one of the bed and trailer, said outer hinge structure being associated with the other of said bed and trailer, and
a hinge sleeve extending through said hinge assembly, wherein said tiltable bed is biased downwardly.

2. The combination of claim 1 wherein the bed further comprises a plurality of independent rollers extending longitudinally between a pair of side rails from a front stop to a rear stop and the trailer further comprising a plurality of traversing members extending between a pair of longitudinally extending members.

3. The combination of claim 2 wherein said bed further comprises a side support.

4. The combination of claim 2 wherein said rollers are further comprised of a frictional outer surface.

5. The combination of claim 1 further comprising an angled receiver having a pair of projecting tabs.

6. The combination of claim 1 wherein said hinge assembly is adapted to receive an axle therethrough.

7. The combination of claim 1 further comprising a latching mechanism securing said bed to said trailer, said latching mechanism comprising a catch associated with said bed and adapted for receiving a latch in communication with an actuator for selective rotation of said latch from said catch whereby said bed rotates about said hinge assembly.

8. The combination of claim 7 wherein said catch has an engageable surface and said latch is complementarily configured for engagement with said engageable surface wherein said catch receives said latch.

9. The combination of claim 7 wherein said actuator is configured for single user operation during unloading of said round bales.

10. The combination of claim 1 further comprising a stand having a first end secured to said bed and a second end adapted for rotation whereby said trailer is spaced from said bed by said stand, said stand adapted for engagement by said trailer for unloading of said round bales from said bed.

11. The combination of claim 10 wherein said first end is mechanically fastened to said bed by a clip pin.

12. A method for transporting round bales using an improved combination hay trailer and tiltable bed for loading and unloading the round bales, said method comprising:
downwardly biasing said bed upon said trailer at a pivot point associated with a hinge assembly,
securing said bed to said trailer using a latching mechanism in communication with an actuator,
operating said actuator for rotation of a front of said bed upwardly about said hinge assembly from a generally horizontal orientation associated with a transport condition to an angled orientation associated with a loading condition, wherein said round bales are loaded or unloaded,
positioning the loading edge for receipt of a plurality of round bales between a pair of side rails,
moving the round bails across a plurality of rollers extending between said side rails,
transitioning said combination towards said transport condition by pivoting said front of said bed downwardly about said pivot point, and
securing said bed to said trailer by said latching mechanism comprising a complementarily configured latch received by a catch each respectively associated with the trailer and the bed.
